(19) United States
(12) Patent Application Publication
(10) Pub. No.: US 2011/0171424 A1
(43) Pub. Date: Jul. 14, 2011

(54) TRANSPARENT POLYESTER FILM COMPRISING BASO4 PARTICLES

(76) Inventors: Holger Kliesch, Ginsheim-Gustavsburg (DE); Martin Jesberger, Mainz (DE); Bodo Kuhmann, Runkel (DE); Ulrich Kern, Ingelheim (DE)

(21) Appl. No.: 12/664,679

(22) PCT Filed: Jun. 11, 2008
(86) PCT No.: PCT/EP08/04656

§ 371 Date: Dec. 21, 2009

(30) Foreign Application Priority Data
Jun. 20, 2007 (DE) 10 2007 028 349.2

(51) Int. Cl. B32B 3/00; B32B 5/16; B32B 7/02; B29C 47/06; B29C 47/88; B29C 55/02

(52) U.S. Cl. 428/141; 428/330; 428/216; 264/171.1; 264/210.1

(57) ABSTRACT

A polyester film with a high transparency, such as a transparency of from 70 to 99.5%, is provided that includes barium sulfate particles whose median particle size is from 0.7 to 7 μm. The barium sulfate particles have an inorganic coating formed from oxides, mixed oxides, or a mixture of oxides of Si, Al, Sn, Fe, In, and/or Sb. The coating makes the barium sulfate particles more compatible with the polyester matrix, thereby minimizing the haze of the film. Preference is given to mixed oxides of SiO₂ and Al₂O₃, and PET is the preferred polyester.

The invention relates to a single- or multilayer, oriented polyester film which comprises BaSO₄ particles which have a specific coating, improving the bonding of the particles into the polyester. This gives a film with high transparency.

The production of stretched polyester films is known, as also is the use of BaSO₄ as white pigment in these films (cf. EP-A-1 728 815).

It is also known that silicon dioxide and aluminum oxide, and also their mixed oxides, have good compatibility in polyester films. Particles of this type are therefore often used for the surface-modification of polyester films (cf. EP-A-1 176 005).

Because silicon dioxide particles and aluminum oxide particles, and also their mixed oxides, have good compatibility, the stretching process produces few, or at least only small, vacuoles, which scatter light and thus increase the haze of the polyester film. In contrast, barium sulfate particles have rather poor compatibility in the polyester matrix, and the stretching process therefore produces vacuoles whose light scattering increases haze and at higher concentrations (e.g. >1%) these lead to an opaque white film. However, it is not only the compatibility of the particles but also their refractive index which is of importance, and in the case of SiOx particles this is generally around 1.5 (mostly 1.46-1.54) and in the case of aluminum oxides it is mostly >1.7. This lies below and, respectively, above the average value of the refractive indices of stretched polyester films (1.57-1.63). However, the closer the refractive index of the particles to that of the polyester, the smaller its contribution to haze or refraction. Here, barium sulfate is precisely within the polyester film range, with values around 1.6, but it is difficult to use in transparent polyester films because of its poor compatibility.

Silicon dioxide, and also its mixed oxides with aluminum, have further disadvantages. These particles react with the polyester during polymer production and during processing with the polyester and during polymer production lead to an undesired rise in viscosity, and during processing often lead to formation of streaks in the final product. Because of the rise in viscosity, by way of example, extrusion masterbatches (where the particles are incorporated into the polymer by means of a multiscrew extruder) based on silicon dioxide can be produced only with relatively low particle concentrations (<3% by weight), or have relatively low quality (with large agglomerates of the particles which subsequently become visible as specks in the film, or block the polymer filters); in this connection see EP-A-1 364 982.

It is therefore an object of the present invention to provide a transparent polyester film which does not have the disadvantages described above.

This object is achieved via a single- or multilayer, oriented polyester film which comprises barium sulfate particles which have a specific coating. This coating improves the compatibility of the (coated) barium sulfate particles in the polyester, the result being a film with high transparency.

Other preferred embodiments of the inventive film are listed below under a)-h), and the present invention encompasses every possible combination or sub-combination of these properties; the inventive film can therefore simultaneously have one, more than one, or all of the properties mentioned:
a) the transparency of the film is from 70 to 99.5%,
b) the roughness of at least one side of the film is from 10-400 nm,
c) the median particle size of the coated barium sulfate is from 0.7 to 7 μm,
d) the barium sulfate has been coated with an inorganic layer,
e) the amount of the barium sulfate present in the film is from 0.005 to 20% by weight (based on the total weight of the film),
f) the thickness of the polyester film is from 0.5 to 500 μm,
g) the film can be produced cost-effectively, and
h) in both directions on the film its modulus of elasticity is greater than 500 N/mm².

The invention also encompasses the use of inventively coated barium sulfate for the production of polyester polymer and of transparent polyester films.

The transparency of the film is preferably from 70 to 99.5%. It has proven advantageous here that the transparency is greater than 80%, preferably greater than 85%, and particularly preferably greater than 90%.

The haze of the film in the thickness range from 0.5 to 50 μm is usually <10%, preferably <5%, and particularly preferably <2.5%.

The haze of the film in the thickness range from 51 to 200 μm is usually <35%, preferably <25%, and particularly preferably <10%.

The haze of the film in the thickness range from 201 to 500 μm is usually <60%, preferably <50%, and particularly preferably <40%.

The roughness of at least one side of the film is preferably from 10 to 400 nm. In order to ensure that the film has good windability, values of from 20 to 300 nm have proven advantageous, and particularly values of from 25 to 250 nm.

The median size d₅₀ of the coated barium sulfate particles is preferably from 0.7 μm to 7 μm. In order to achieve the desired roughness values, the median particle size (d₅₀) is in particular from 1.0 to 6 μm, and particularly preferably from 1.2 to 3.5 μm. Particles smaller than 0.7 μm lead to inadequate surface roughness and therefore would have to be added at very high concentrations and then sometimes lead to high haze. Particles whose d₅₀ is above 7 μm prove, even with coating, to be insufficiently compatible in the polymer matrix, and this likewise leads to high haze and moreover to marked abrasion of the particles during further processing.

The thickness of the film is preferably ≧0.5 μm and ≦500 μm, and in particular from 7 to 250 μm, and preferably from 10 to 100 μm.

Capability of cost-effective production includes the capability of the film to undergo biaxial orientation without break-off during its production, and avoidance of any visible color alteration even when from 40 to 80% of recycled material of the same type is used, and less tendency toward streaking in production than a comparable film using SiO₂ particles.

The good mechanical properties include inter alia a high modulus of elasticity in the longitudinal direction (MD) and transverse direction (TD): greater than or equal to 500 N/mm², preferably greater than or equal to 2000 N/mm², and particularly preferably greater than or equal to 4000 N/mm².

In one preferred embodiment, the shrinkage of the film according to the invention is not greater than 25% at 200° C. in any direction on the film (either MD or TD). Shrinkage at 200° C. is preferably less than or equal to 10%, in particular less than or equal to 4%. This is advantageous, since the film can then give good processing without creasing, even at an elevated temperature in further steps of processing (metallization, lamination, etc.).

The inventive film comprises polyester as main polymer constituent (i.e. preferably an amount of from 55 to 100% by weight, in particular from 70 to 100% by weight, and particularly preferably from 90 to 100% by weight).

According to the invention, a polyester is
homopolyester,
copolyester, or
a blend of various polyesters,
   where the form in which these are used can be either pure polymers or else polyester polymers comprising recycled material.

Polyesters contain repeat units which derive from dicarboxylic acids (100 mol %) and from diols (likewise 100 mol %). The inventive polyesters are preferably based on terephthalic acid or naphthalene-2,6-dicarboxylic acid as dicarboxylic acid, and on ethylene glycol or 1,4-butanediol as diol (examples being polyethylene terephthalate (PET), polybutylene terephthalate (PBT), or polyethylene 2,6-naphthalate (PEN)).

The inventive polyesters in particular contain from 10 to 100 mol % of terephthalate (preferably >50 mol %, and particularly preferably >90 mol %, of terephthalate) and/or from 10 to 100 mol % of 2,6-naphthalate, as dicarboxylic acid components, where the total amount of dicarboxylic acid components makes up 100 mol %. The inventive polyester can preferably contain, as further dicarboxylic acid components, from 0 to 50 mol % of 2,6-naphthalate (if terephthalate has been used as main component), from 0 to 50 mol % of terephthalate (if naphthalate has been used as main component), from 0 to 20 mol % of isophthalate (preferably from 0.5 to 10 mol %), or else from 10 to 60 mol % of biphenyl-4,4′-dicarboxylate. The proportion of other dicarboxylic acid components, such as naphthalene-1,5-dicarboxylate, should, if these are present, not exceed 30 mol %, preferably not exceed 10 mol %, and in particular not exceed 2 mol %. Embodiments with at least 0.5 mol % of isophthalic acid, preferably at least 1 mol % of isophthalic acid are particularly preferred, since these are less brittle and are more capable of adapting to changes in shape during subsequent processing.

The inventive polyester generally contains from 10 to 100 mol % of ethylene glycol (EG), where the total amount of diol components makes up 100%. If a mixture of different diols is used, it is advantageous not to exceed a proportion of 10 mol % of diethylene glycol, and preferably to use from 0.5 to 5 mol %. The proportions of other diol components, such as cyclohexanedimethanol, 1,3-propanediol and 1,4-butanediol, should advantageously not exceed 50 mol %, and are preferably less than 30 mol %, particularly preferably less than 10 mol %.

The polyesters mentioned can also be used in the form of mixtures. PET is particularly preferred.

Other embodiments of the film can comprise, alongside the main polymer constituents mentioned, up to 45% by weight, preferably up to 30% by weight, particularly preferably up to 20% by weight, based on the total weight of the film, of other polymers, such as polyetherimides (e.g. Ultem® 1000 from GE Plastics Europe, NL), polycarbonate (e.g. Makrolon® from Bayer, DE), polyolefins, such as COCs (e.g. Topas® from Ticona, DE), polyamides (Ultramid® from BASF, DE) inter alia.

The polyesters are generally prepared from the diols and dicarboxylic acids mentioned, or from dicarboxylic esters, by processes known from the literature. The polyesters can be prepared either by the transesterification process using the conventional catalysts, such as the salts of Zn, of Ca, of Li, and of Mn, or by the direct esterification process.

The barium sulfate particles can be produced by known processes as described by way of example in WO 00/76919, or commercially available products can be used, an example being the ®Blanc Fix product line from Sachtleben, DE. These particles can preferably be coated by known processes with an inorganic coating. These processes are described inter alia in EP-A-0 459 552 (column 3 and examples) or DE-A-103 33 029 ([0027]-[0037] and examples 1-3) and DE-A-10 2006 031 630, preference being given to the sol-gel process.

Coatings that can be used are oxides or their mixtures, or mixed oxides of Si, Al, Sn, Fe, In, Zr, Ce and Sb, preference being given to oxides of Si and Al, and particular preference being given to mixed oxides of Si and Al or use of pure silicon oxides, particularly SiO₂ and Al₂O₃ or their mixtures/mixed oxides. The proportion of these oxides (coating), based on the total weight of the coated particles, is usually less than 15% by weight, preferably less than 3% by weight, and particularly preferably less than 2% by weight. A low proportion of the coating, based on the total weight of the particles, has an advantageous effect on the haze of the film, since the refractive index of BaSO₄ thus retains a higher weighting. If the proportion by weight for the coating is below 0.1% by weight, it is very difficult to obtain a coating that covers the surface of the particles, and there can sometimes be loss of compatibility of the particles in the polyester, the result again being a rise in the haze of the resultant film. A proportion of >0.3% by weight of the coating is advantageous, and >0.7% by weight is particularly advantageous.

The amount of the coated barium sulfate particles added to the film is preferably from 0.005 to 20% by weight. The content is usually from 0.01 to 5% by weight (based in each case on the total weight of the film).

The inventive film can comprise further particulate additives, e.g. antiblocking agents, alongside the barium sulfate particles. Typical antiblocking agents are inorganic and/or organic particles, such as silicon dioxide (natural, precipitated, or fumed), calcium carbonate, magnesium carbonate, barium carbonate, calcium sulfate, barium sulfate (not inorganically coated), lithium phosphate, calcium phosphate, magnesium phosphate, titanium dioxide (rutile or anatase), kaolin (hydrated or calcined), aluminum oxide, aluminum silicate, lithium fluoride, the calcium, barium, zinc, or manganese salts of the dicarboxylic acids used, or crosslinked polymer particles, e.g. polystyrene or polymethyl methacrylate particles and it is preferable that the coated barium sulfate is combined with silicon dioxide as antiblocking agent.

The median size (d₅₀ value) of the other particulate additives is usually from 0.01 to 15 μm, preferably from 0.03 to 10 μm, and particularly preferably from 0.05 to 5 μm. In one preferred embodiment, the proportion of particles whose d₅₀ value is greater than or equal to 3 μm is less than or equal to 2000 ppm, and particularly preferably less than or equal to 1000 ppm.

In one preferred embodiment, the amount in % by weight of coated barium sulfate is greater than the entirety of the other filler/particles in % by weight, and particularly preferred embodiments are those in which at least 85% by weight of the filler is composed of the coated barium sulfate.

It is also possible to select a mixture of two or more of the abovementioned particle systems, or a mixture of particle systems with identical chemical constitution but of different particle sizes. It is advantageous that the particles are added to the polyester before melting begins.

The film has a structure of one or more layers, structures having more than one layer being preferred. Particular preference is given here to structures having at least three layers. Here, the coated barium sulfate is preferably added only to one or both external layers. Any other particles present are also preferably only added to the external layers. Particles in interior layers preferably derive from recycled material of the same type from the respective film. The proportion of coated barium sulfate in at least one external layer is preferably from 0.01 to 20% by weight and particularly preferably from 0.1 to 5% by weight (based on the total weight of the appropriate external layer). The weight of the layer comprising coated barium sulfate is preferably at least 2% by weight of the total weight of the film, particularly preferably at least 5% by weight of the total weight of the film.

In multilayer structures, the proportion of all of the particulate additives, including that of the coated barium sulfate, is usually below 5% by weight, preferably below 1% by weight, and particularly preferably below 0.5% by weight based on the total weight of the film. The inventive film can comprise further additives, such as dyes, UV stabilizers, flame retardants, hydrolysis stabilizers, and/or antioxidants, particular preference being given here to UV stabilizers from the Tinuvin® product line from Ciba SC, CH.

The film can also be coated to provide further proerties. Typical coatings are in particular those having adhesion-promoting, antistatic, slip-improving, or release action. These additional layers can be applied to the film by way of in-line coating, by means of aqueous dispersions, after longitudinal stretching and prior to transverse stretching.

The additives, i.e. the coated barium sulfate particles and any further fillers and other additives (such as UV stabilizers) present are preferably introduced into the polymer by means of a commercially available twin-screw extruder. In this process, the polyester according to the invention in pellet form is introduced into the extruder together with the particles/additives and is extruded, and then quenched in a water bath and then pelletized.

However, the additives can also be added directly during the polyester production. This process is less preferred for dyes and UV stabilizers, because of the additional thermal stress. In the case of the DMT process (DMT=dimethyl terephthalate), the additives are usually added after transesterification and, respectively, directly prior to polycondensation (e.g. by way of the transport line between transesterification vessel and polycondensation vessel), in the form of a glycolic dispersion. However, the addition can also take place before transesterification begins. In the case of the TPA process (TPA=terephthalic acid), the addition preferably takes place at the start of the polycondensation process. However, later addition is also possible. In this process it has proven advantageous that the glycolic dispersions are filtered prior to addition by way of a PROGAF PGF 57® (Hayward/Ind., USA) filter. This process is preferred for polymers which comprise SiO₂ particles, since these are difficult to incorporate in the extrusion masterbatch process.

The present invention also provides a process for the production of the film. Production generally takes place via an extrusion process. It has proven particularly advantageous to add all the additives, such as particles, UV stabilizers, flame retardants, hydrolysis stabilizers, and antioxidants, in the amounts mentioned, in the form of masterbatches, prior to extrusion.

In masterbatch technology it is preferable that polyester polymers comprising additive can be combined with inexpensive unfilled polymers. Although the costs here are dependent to some extent on the filler level, the largest step in costs is the presence of additive per se. It is therefore economically advantageous to combine a masterbatch having maximum fill level with an unfilled polyester.

The polyester films can be produced in the form of a single- or multilayer film by known processes from a polyester polymer and, if appropriate, further raw materials.

If twin- and multi-screw extruders are used, the masterbatches, and also the other raw materials, can be extruded directly, without predrying. If single-screw extruders are used, it is advisable to dry the material for at least 1 hour at 120 to 150° C.

In the preferred coextrusion process for the production of film, the melts corresponding to the individual layers of the film are coextruded through a flat-film die and quenches in the form of a substantially amorphous pre-film on a chill roll. This film is then reheated and oriented in at least one direction, or longitudinally and transversely, or transversely and longitudinally, or longitudinally, transversely, and again longitudinally and/or transversely. The temperatures of the film in the stretching process are generally from 10 to 60° C. above the glass transition temperature T_{g} of the polyester used, and the longitudinal stretching ratio is preferably from 2 to 6, in particular from 3 to 4.5, and the transverse stretching ratio is preferably from 2 to 5, in particular from 3 to 4.5, and the stretching ratio for any second longitudinal and transverse stretching carried out is preferably from 1.1 to 5. The first longitudinal stretching can also be carried out simultaneously with the transverse stretching (simultaneous stretching). Heat-setting of the film then follows at oven temperatures of about 180 to 260° C., preferably from 220 to 250° C. The film is then cooled and wound. A biaxially oriented film is preferred.

In one preferred embodiment, the heat-setting takes place at temperatures of from 220 to 250° C., and the film is relaxed transversely at this temperature by at least 1%, preferably at least 2%.

In another preferred embodiment, the heat-setting takes place at from 220 to 250° C., and the film is transversely relaxed at this temperature by at least 1%, preferably by at least 2%, and is then again relaxed at temperatures of from 180 to 150° C. by at least 1%, preferably at least 2% in the cooling phase.

In another preferred embodiment, the film is stretched in MD and TD by a factor of at least 3, and the stretching here takes place in a simultaneous frame. The heat-setting takes place at from 220 to 250° C., and the film is longitudinally and transversely relaxed by at least 1% at this temperature. (MD=machine direction or longitudinal direction, TD=transverse direction.)

The inventive single- or multilayer films have the good mechanical properties demanded. For example, the modulus of elasticity is greater than or equal to 500 N/mm² in at least one direction on the film.

The shrinkage of the film is not greater than 25% at 200° C. in any direction on the film (either MD or TD).

Because the coated barium sulfate particles can also be incorporated at concentrations above 3% by weight and indeed above 7% by weight into masterbatches, in particular also into extrusion masterbatches, considerable raw material cost savings are possible in comparison with SiO₂-filled polymers.

The film is suitable for almost any of the known polyester film applications, e.g. packaging applications, for metalizing, for motor film, etc., and particularly for any of the applications where the film has to have good optical properties, e.g. high transparency.

The following standards or methods were used in measuring the individual properties as in the description and in the examples:

### Test Methods

DIN=Deutsches Institut für Normung [German Standards Institute]

ISO=Internat. Organization for Standardization

ASTM=American Society for Testing and Materials

### Mechanical Properties

Modulus of elasticity, ultimate tensile strength, ultimate tensile strain, and F₅ value are measured longitudinally and transversely to ISO 527-1-2 with the aid of tensile-strain-measurement equipment (010 from Zwick, DE).

### Shrinkage

Thermal shrinkage is determined on the square film samples whose edge length is 10 cm. The specimens are measured precisely (edge length L₀), heat-conditioned at 200° C. in a convection drying cabinet for 15 min, and then measured precisely at room temperature (edge length L). Shrinkage is given by the equation

Shrinkage[%]=100·(L₀−L)/L₀

Measurement of Median Diameter (Particle Size) d₅₀

Median diameter d₅₀ is determined by means of a laser on a Malvern Master Sizer (Malvern Instruments Ltd., UK) by the standard method. Examples of other measurement equipment are the Horiba LA 500 (HORIBA Europe GmbH, DE) or the Sympathec Helos (Sympathec GmbH, DE), which use the same principle of measurement. The specimens for measurement are placed in a cell with water and this is then placed in the measurement equipment. The measurement procedure is automatic and also includes the mathematical determination of the d₅₀ value.

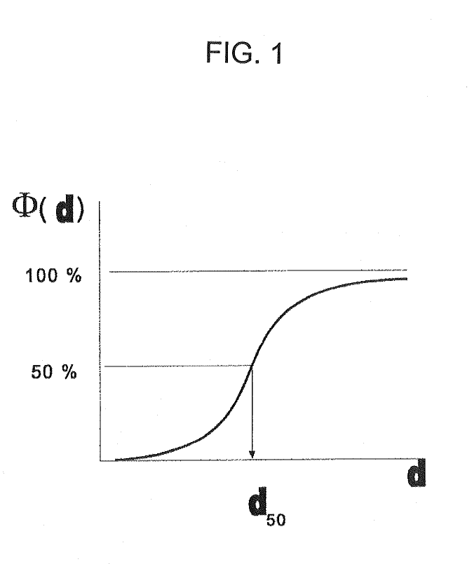

The d₅₀ value here is by definition determined from the (relative) cumulative curve of particle size distribution. The intersection of the 50% ordinate value with the cumulative curve directly gives the desired d₅₀ value on the abscissa axis (cf. in this connection FIG. 1).

### Measurement of Haze

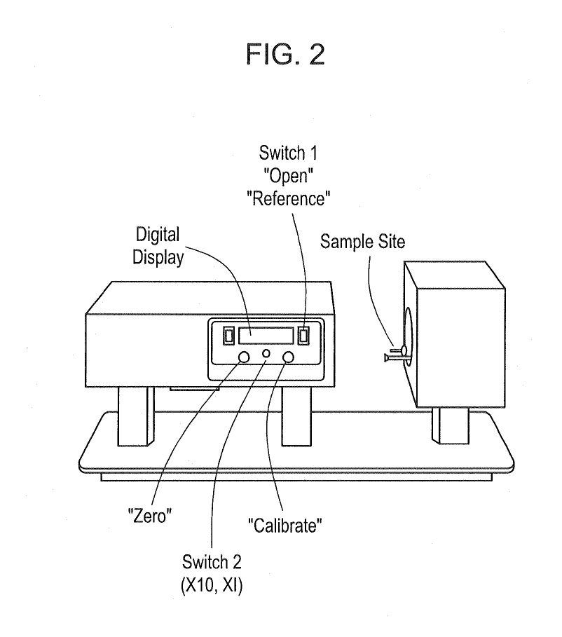

The measurement is made using the Hazegard Hazemeter XL-211 from BYK Gardner (see FIG. 2). The measurement equipment is to be switched on 30 minutes prior to measurement. Care has to be taken that the light beam passes through the sphere centrally to the exit aperture.

### Production, Shape, and Number of Specimens

In each case, 5 specimens of size 100×100 mm are cut out from the film to be tested. The longitudinal direction and transverse direction are indicated on the margin, since measurements are made in both directions.

### Measurement of Haze

press switch 1 to “OPEN”
set switch 2 to “X10” and calibrate digital display to “0.00” using the “Zero” knob
move switch 1 to “Reference” and switch 2 to “X1”
bring the digital display to 100, using the “Calibrate” knob
insert specimen longitudinally
calibrate the digital display to 100, using the “Calibrate” knob
set switch 1 to “OPEN”
read displayed value for longitudinal haze
rotate specimen in transverse direction
read displayed value for transverse haze

### Evaluation

Haze is obtained by averaging the respective 5 individual values (longitudinally and transversely).

### Yellowness Index

Yellowness index Y (YID) is the deviation from the colorless state in the “yellow” direction, and is measured to DIN 6167.

### Transparency

Transparency is measured to ASTM D1033-77.

### Roughness

The roughness Rₐ of the film is determined to DIN 4768.

### Film Production

Polyester chips are mixed in the ratios stated in the examples and in each case melted in twin-screw extruders, without predrying. The molten polymer extrudates are combined in a coextrusion die and drawn off by way of a take-off roll (roll temperature 20° C.). The film is stretched by a factor of 3.9 in the machine direction at 116° C. (film temperature in the stretching gap) and transverse stretching is carried out at 110° C. in a frame, by a factor of 3.8. The film is then heat-set at 229° C. and transversely relaxed by 1.5% at temperatures of 225° C. and again by 1.5% at temperatures from 180 to 150° C. The production speed (final film speed) is 300 m/min.

### EXAMPLES

The following raw materials are used in the examples:

### Masterbatch MB1

Extrusion masterbatch with 10% by weight of BaSO₄ (BaSO₄=Blanc Fixe® N, median particle size d₅₀=1.7 μm, from Solvay Chemicals was coated with a layer composed of SiO₂, 90%, and Al₂O₃, 10%, the proportion of SiO₂+Al₂O₃ being 1.8% by weight, based on the barium sulfate, and the proportion of the barium sulfate therefore being about 98% by weight) in polyethylene terephthalate (PET). The coated barium sulfate here was added to the feed zone of a Werner & Pfleiderer (DE) twin-screw extruder, together with the polyester polymer T94 from Invista, DE, and extruded and pelletized.

### Production of Coated Barium Sulfate:

2000 g of BaSO₄ (Blanc Fixe® N) were mixed into about 5 l of PD water (PD: partially demineralized), using a paddle stirrer. The suspension was heated to 80° C. and brought to pH 6.5 by means of NaOH and sulfuric acid. 150 ml of waterglass solution (corresponding to 380 g of SiO₂/l) were then added at 80° C. to the suspension at constant pH (pH=6.5±0.5; regulation via addition of H₂SO₄). After addition was complete, the mixture was stirred for 20 min at pH=6.8 and 80° C. and then adjusted with NaOH to pH 7.0. 25 ml of sodium aluminate solution (content corresponding to 300 g of Al₂O₃ per liter) were then slowly added (8 ml/min) at constant pH. During the addition, the pH was kept at constant pH=7 with the aid of sulfuric acid. Once addition was complete, the mixture was stirred for two hours at pH=7 and 80° C. The material was then filtered in a suction filter, and the filtercake was washed until filtrate conductivity was below 100 μS/cm, and dried at 105° C. in a drying cabinet. The product was then heat-conditioned for a further 30 min in a muffle furnace at 500° C.

### Masterbatch MB2

Extrusion masterbatch with 10% by weight of SiO₂ (Silysia® 320, median particle size d₅₀=2.5 μm, from Fuji Sylysia, JP) in polyethylene terephthalate (PET). The silicon dioxide here was added to the feed zone of a Werner and Pfleiderer twin-screw extruder, together with the polyester polymer T94 from Invista, DE, and extruded and pelletized.

### Masterbatch MB3

Extrusion masterbatch with 10% by weight of BaSO₄ (Hombright® S, median particle size d₅₀=0.5 μm, from Sachtleben Chemie GmbH) in polyethylene terephthalate (PET). The particles had been coated with an inorganic coating of Al(III) and Si(IV), and the proportion of barium sulfate here was only about 95% by weight. The coated barium sulfate here was added to the feed zone of a Werner & Pfleiderer twin-screw extruder, together with the polyester polymer T94 from Invista, and extruded and pelletized.

### Masterbatch MB4

Extrusion masterbatch with 10% by weight of BaSO₄ (Blanc Fixe N, median particle size d₅₀=1.7 μm, from Solvay Chemicals) in polyethylene terephthalate (PET). The uncoated barium sulfate here was added to the feed zone of a Werner & Pfleiderer twin-screw extruder, together with the polyester polymer T94 from Invista, and extruded and pelletized.

### Polymer P1

100% by weight of polyethylene terephthalate RT49 from Invista, DE

### Inventive Example 1

A 12 μm ABC film was produced as stated above, the thickness of the base layer (B) being 8 μm and that of each of the outer layers A and C being 2 μm.

Outer layers A and C: 2% of MB1 and 98% of P1

Mixture of raw materials for base layer B: 100% of P1

Problem-free production. No streaking within 24 h of production. One break-off in 48 h.

Haze, 1.8%. Transparency, 90.5%. Longitudinal modulus of elasticity, 4800 N/mm². Transverse modulus of elasticity, 5050 N/mm². Shrinkage at 200° C.=3.1% longitudinally and 0.3% transversely. Roughness Rₐ=40 nm

### Comparative Example 1

An ABC film was produced as stated above, the thickness of the base layer (B) being 8 μm and that of each of the outer layers A and C being 2 μm.

Outer layers A and C, 1.5% of MB2 and 98.5% of P1

Mixture of raw materials for base layer B: 100% of P1

Cost-effective production not possible. Many break-offs (<10 per day), inter alia due to pressure changes in the extruders which contain the MB2. Film streaky and cloudy.

Haze, 3.8%. Transparency, 87%. Longitudinal modulus of elasticity, 4750 N/mm². Transverse modulus of elasticity, 4910 N/mm². Shrinkage at 200° C.=3.2% longitudinally and 0.32% transversely. Roughness Rₐ=43 nm

### Comparative Example 2

A 12 μm ABC film was produced as stated above, the thickness of the base layer (B) being 8 μm and that of each of the outer layers A and C being 2 μm.

Outer layers A and C: 2% of MB3 and 98% of P1

Mixture of raw materials for base layer B: 100% of P1

Problem-free production. No streaking within 24 h of production. One break-off in 48 h. However, wind-up of the film was difficult because of the low surface roughness, and creasing and longitudinal corrugations occurred.

Haze, 1.1%. Transparency, 91%. Longitudinal modulus of elasticity, 4830 N/mm². Transverse modulus of elasticity, 5010 N/mm². Shrinkage at 200° C.=3.2% longitudinally and 0.3% transversely. Roughness Rₐ=9 nm

### Comparative Example 3

An ABC film was produced as stated above, the thickness of the base layer (B) being 8 μm and that of each of the outer layers A and C being 2 μm.

Outer layers A and C: 2% of MB4 and 98% of P1

Mixture of raw materials for base layer B: 100% of P1

Problem-free production. No streaking within 24 h of production. One break-off in 48 h. However, increased abrasion generating white dust occurred during wind-up and during trimming of the edges.

Haze, 11%. Transparency, 84%. Longitudinal modulus of elasticity, 4845 N/mm². Transverse modulus of elasticity, 4930 N/mm². Shrinkage at 200° C.=3.2% longitudinally and 0.3% transversely. Roughness Rₐ=54 nm

1. An oriented polyester film comprising barium sulfate particles, wherein said barium sulfate particles further comprise an inorganic coating.

2. The polyester film as claimed in claim 1, wherein the coating comprises oxides, mixed oxides, or a mixture of oxides of Si, Al, Sn, Fe, In and/or Sb.

3. The polyester film as claimed in claim 1, wherein the coating comprises silicon oxide or aluminum oxide.

4. The polyester film as claimed in claim 1, wherein the coating comprises mixed oxides or a mixture of silicon oxide and aluminum oxide.

5. The polyester film as claimed in claim 1, wherein the coating comprises mixed oxides or a mixture of SiO₂ and Al₂O₃.

6. The polyester film as claimed in claim 1, wherein the median particle size (d₅₀) of the coated barium sulfate particles is from 0.7 to 7 μm.

7. The polyester film as claimed in of claim 1, wherein the proportion of the coating, based on the total weight of the coated barium sulfate particles, is less than 15% by weight.

8. The polyester film as claimed in claim 1, wherein the coating, based on the total weight of the coated barium sulfate particles, is present in a proportion of less than 3% by weight.

9. The polyester film as claimed in claim 1, wherein said film comprises from 0.005 to 20% by weight of coated barium sulfate particles.

10. The polyester film as claimed in claim 1, wherein said film comprises a polyester which has terephthalic acid units and/or naphthalene-2,6-dicarboxylic acid units.

11. The polyester film as claimed in claim 1, wherein said film comprises polyethylene terephthalate.

12. The polyester film as claimed in claim 1, wherein said film is a multilayer film.

13. The polyester film as claimed in claim 1, wherein said film has an ABC layer structure, where A and C are external or outer layers and B is a base or internal layer.

14. The polyester film as claimed in claim 13, wherein the external layers and the base layer of the film comprise the same polyester.

15. The polyester film as claimed in claim 1, wherein said film has at least 3 layers, and only the external layers or only one external layer comprise(s) the coated barium sulfate particles.

16. The polyester film as claimed in claim 1, wherein said film has at least 3 layers, and one or both external layers comprise(s) from 0.1 to 3% by weight of coated barium sulfate particles.

17. The polyester film as claimed in claim 1, wherein said film has a transparency of from 70 to 99.5%.

18. The polyester film as claimed in claim 1, wherein said film ranges in thickness from 0.5 to 50 μm and exhibits a haze of less than 2.5%.

19. The polyester film as claimed in claim 1, wherein said film has a roughness on at least one side of from 10 to 400 nm.

20. A process for the production of a polyester film as claimed in claim 1, comprising the steps of
a) producing a single- or multilayer film via extrusion or coextrusion,
b) stretching the film, and
c) heat-setting the stretched film.

21. The process as claimed in claim 20, said process further comprising transversely relaxing the film by at least 1% during the heat-setting.

22. A packaging material or protective film comprising the polyester film as claimed in claim 1.

23. Polyester polymer comprising barium sulfate particles, said barium sulfate particles further comprising an inorganic coating and said polymer exhibiting a transparency of from 70 to 99.5%.
